(19) United States
(12) Patent Application Publication
(10) Pub. No.: US 2013/0209298 A1
(43) Pub. Date: Aug. 15, 2013

(54) VALVE, IN PARTICULAR OF A HYDRAULIC PISTON PUMP

(71) Applicants: Oliver Gaertner, Abstatt (DE); Wolfgang Schuller, Cleebronn (DE); Michael Schuessler, Seckach (DE)

(72) Inventors: Oliver Gaertner, Abstatt (DE); Wolfgang Schuller, Cleebronn (DE); Michael Schuessler, Seckach (DE)

(73) Assignee: Robert Bosch GmbH, Stuttgart (DE)

(21) Appl. No.: 13/817,385

(22) PCT Filed: Jun. 21, 2011
(86) PCT No.: PCT/EP11/60291

§ 371 Date: Apr. 29, 2013

(30) Foreign Application Priority Data
Aug. 19, 2010 (DE) 10 2010 039 516.1

(51) Int. Cl. F16K 15/02; F04B 53/10; F16K 99/00

(52) U.S. Cl. CPC F16K 15/028; F16K 99/00; F04B 53/1032
USPC 417/443; 137/15.18; 137/542

(57) ABSTRACT

In a valve, in particular of a hydraulic pixton pump, includes a valve seat, a valve closing element, and a positioning mechanism. A valve opening is formed in the valve seat. The valve seat also has a front side and a rear side. The valve closing element is arranged on the front side of the valve seat in order to open and close the valve opening as desired. The positioning mechanism is configured to hold the valve closing elementrelative to the valve seat. The positioning mechanism is arranged on the rear side of the valve seat and is connected to the valve closing element through the valve opening.

### PRIOR ART

The invention relates to a valve, in particular of a hydraulic piston pump, having a valve seat, in which a valve opening is formed and which has a front side and a rear side, a valve closing element, which is arranged on the front side of the valve seat for selective opening and closing of the valve opening, and a positioning means, which holds the valve closing element relative to the valve seat. The invention furthermore relates to a method for producing a valve, to a hydraulic piston pump and to a vehicle braking system.

Hydraulic piston pumps such as those in vehicle braking systems generally have ball valves as inlet and outlet valves since they can be produced at relatively low cost.

A valve of this kind in the form of a ball valve is usually arranged in a valve housing, which is clamped securely on a holder belonging to a piston that can be extended and retracted in a cylinder. The inlet valve is provided in order to allow fluid to be sucked into a pressure zone within the cylinder through an inlet device by means of a stroke motion of the piston. The fluid under pressure is then pumped out of the pressure zone into a hydraulic system through the outlet valve in order to perform work.

The valve housing is generally configured in a cupshape as a cage, within which there is a helical return spring that presses against a spherical closing element. As a result, the spherical closing element rests against a valve seat formed on the end of the piston.

When the piston is pushed out of the cylinder by means of a return spring, the closing element of the inlet valve is thus raised from the valve seat against the force of the return spring since a vacuum is built up in the cylinder. During this movement of the piston, the inlet valve is opened, and fluid is sucked into the pressure zone via the inlet device.

When the piston is pushed into the cylinder by means of an eccentric, the inlet valve closes and the outlet valve is opened since the closing element is raised at that point against a spring force. The fluid is pumped out of the pressure zone into a hydraulic system in order to perform work.

DE 10 2008 043 841 A1 discloses a ball valve, in particular a high-pressure valve for high-pressure pumps in fuel injection systems, having a valve ball and a valve seat surface, wherein the valve ball interacts with the valve seat surface to give a sealing seat in order to interrupt a connection between an inlet and an outlet. In this case, the valve ball is urged against the valve seat surface by means of a helical return spring.

Moreover, DE 10 2004 028 889 A1 discloses a piston pump for delivering hydraulic fluid, having a cylinder element, a piston that can move backward and forward in the cylinder element, and a piston chamber, in which the hydraulic fluid can be subjected to pressure by means of the piston. The piston pump furthermore comprises an outlet valve and a slot-controlled inlet valve. In the outlet valve, a valve ball as a closing element is urged against an associated valve seat by means of a disk-shaped return spring.

### DISCLOSURE OF THE INVENTION

The invention provides a valve, in particular of a hydraulic piston pump, having a valve seat, in which a valve opening is formed and which has a front side and a rear side, a valve closing element, which is arranged on the front side of the valve seat for selective opening and closing of the valve opening, and a positioning means, which holds the valve closing element relative to the valve seat, wherein the positioning means is arranged on the rear side of the valve seat and connected to the valve closing element through the valve opening.

The hydraulic piston pump preferably comprises a cylindrical piston, which is supported within a cylinder in a manner which allows it to be extended and retracted. A pressure zone filled with a fluid is provided within the cylinder and sealed off. As the piston is extended from the cylinder, a vacuum is built up in the pressure zone, and the piston sucks fluid into the pressure zone via an inlet valve. During retraction, the piston displaces the fluid from the pressure zone into a hydraulic system via an outlet valve in order to perform work.

In the present case, the term “fluid” is to be taken to mean a gas and/or a liquid, such as a hydraulic fluid based on mineral oil or glycol.

The inlet valve and/or the outlet valve is/are advantageously configured as a valve according to the invention. The valve according to the invention has a valve seat with a valve opening, a valve closing element, and a positioning means, which holds the valve closing element relative to the valve seat. The valve seat comprises a front side and a rear side, with the valve closing element being arranged on the front side of the valve seat and the positioning means being arranged on the rear side of the valve seat. The valve closing element and the positioning means are connected to one another through the valve opening in a manner which allows the transmission of forces. The term “rear side” of the valve seat is to be taken to mean the side on which the fluid flows into the valve opening, and the term “front side” is to be taken to mean the side on which the fluid flows out of the valve opening.

As the piston is extended from the cylinder, fluid is sucked into the pressure zone through the inlet valve owing to the vacuum which is generated. In this process, the valve closing element is raised by a certain distance from the valve seat, and the fluid flows through the valve opening into the pressure zone. As the piston is extended from the cylinder, the outlet valve is closed in a substantially fluidtight manner.

As the piston is retracted into the cylinder, the inlet valve is closed. Owing to the pressure generated in the pressure zone, the valve closing element of the outlet valve is raised, and the valve opening is opened. Fluid then flows out of the pressure zone, along the outlet valve, into a hydraulic system in order to perform work.

According to the invention, the valve comprises a positioning means, which is arranged on the rear side of the valve seat and connected to the valve closing element through the valve opening. This positioning means positions the valve closing element on the valve seat, that is to say the positioning means guides the valve closing element over a defined distance during the opening and closing of the valve. In particular, the positioning means guides the valve closing element to a predefined position on the valve seat during the closing of the valve, in which position the valve closing element forms a substantially fluidtight seal with the valve seat. The valve closing element can thus be mounted in such a way as to be free—i.e. without a spring—and is guided accurately onto the sealing seat during the closing operation by means of the positioning means, which projects through the valve opening. The valve according to the invention can thus be constructed without a spring.

The positioning means is preferably configured in such a way that an offset or section of elongate design is arranged on an end of the valve closing element which faces the valve opening. This elongate offset is accommodated within the valve opening. In this case, the positioning means is spaced apart from an inner wall of the valve opening and enables the fluid to flow through the valve opening between the inner wall of the valve opening and an outer wall of the positioning means when the valve closing element is raised. The positioning means is preferably formed integrally with the valve closing element.

One advantage of the invention is that, on the one hand, the valve according to the invention ensures a good fluidtight seal, i.e. an easy and good closing action, and responds quickly and precisely even at low pressures. On the other hand, the positioning means and/or the valve closing element connected to the positioning means can be produced at low cost and has a low self weight. The valve provided is novel and does not require a helical return spring that involves a complex assembly operation and has to be held in a valve cage. Owing to the very simple construction of the valve according to the invention, production costs can be reduced.

Moreover, the valve according to the invention requires a relatively small installation space since a helical return spring, which is usually arranged on the front side of the valve seat, is eliminated. Optimum use is made of the installation space. In particular, this makes it possible to increase the installation space for a pulsation damping element, thereby making it possible to reduce a pressure pulsation level of the piston pump.

The positioning means preferably positions the valve closing element in the direction of the longitudinal extent of the valve or axial direction.

Here, the function of the positioning means is to guide and position the valve closing element axially relative to the valve seat and to the valve opening. In particular, in the present case the positioning means has a cylindrical offset with a limiting element which limits the length of the stroke of the valve closing element in the axial direction. As the valve opening opens when the valve closing element is raised from the valve seat, the positioning means guides the valve closing element in the longitudinal direction. Once the valve closing element has been raised by a certain distance from the valve seat, the limiting element strikes against the rear side of the valve seat and comes to rest there. In this way, the stroke of the valve closing element is limited, and the travel of the valve closing element is thus limited. The positioning means provided thus ensures defined stroke limitation, that is to say the position of the valve closing element in the open position is precisely defined.

The positioning means furthermore advantageously positions the valve closing element transversely to the longitudinal extent of the valve.

Here, the positioning means is intended to guide and position the valve closing element radially relative to the valve seat and to the valve opening. In order to position the valve closing element in this way in the radial direction relative to the valve seat and to the valve opening and to hold it in the desired radial position during the stroke, the positioning means has, in particular, a cylindrical offset which rests relatively snugly against the inner wall of the valve opening. When the valve closing element is raised from the valve seat during the opening of the valve, the positioning means guides the valve closing element, ensuring that essentially it does not slip in the radial direction and reassumes its original position during a closing operation of the valve.

The positioning means furthermore preferably comprises a latching element, which is latched in on the rear side of the valve seat.

In the present case, the latching element is designed to be elastic, in particular in the radial direction, and is preferably formed integrally with the positioning means. The valve closing element is therefore arranged on the front side of the valve seat and is connected to the latching element by the positioning means, which projects through the valve opening. The latching element is arranged on the rear side of the valve seat, preferably loosely. Thus, the valve closing element is not merely inserted only loosely into the valve opening but is mounted in a captive manner there. The valve closing element can thus form a preassembled module with the valve seat that is easy to handle during an assembly process for the hydraulic piston pump. In particular, the latching element ensures, preferably by means of a sufficiently long configuration of the positioning means, that the valve closing element can be raised from the valve seat by a predetermined stroke without the latching element hindering or restricting this stroke. The latching element thus preferably does not act as a return spring exerting a pulling force on the valve closing element.

In particular, the latching element is configured in such a way that it is snapped in or latched in on the rear side of the valve seat. For this purpose, the latching element preferably has two legs spread apart elastically. When the latching element is mounted on the valve seat, the latching element is pushed through the valve opening from the front side of the valve seat. During this process, the elastic legs are pressed together. Once the latching element is arranged on the rear side of the valve seat, the legs spread apart elastically and latch in on the rear side of the valve seat. The valve closing element is held captive on the valve seat.

A return means, in particular a spring, is preferably arranged on the rear side of the valve seat, urging the valve closing element against the valve seat.

The return means, preferably in the form of a return spring, can be configured as a spring wire of elongate configuration or, alternatively, as a flat-wound bending spring, such as a spring washer or spring plate, a leaf spring or a spiral spring. The leaf spring preferably consists of a flat metal strip or metal wire which is prestressed in an arc. The spiral spring is preferably produced from a metal strip or metal wire wound in one plane in a spiral. A spiral spring or indeed a spring washer are particularly easy to mount in the valve. The return spring preferably consists of a spring steel, such as a copper-beryllium alloy. The return means urges the valve closing element against the front side of the valve seat with a defined clamping force from the rear side of the valve seat and, as a result, the valve opening is closed in a substantially fluidtight manner in the closed state of the valve. By means of this development, a “spring-mass-optimized” valve is created, requiring only a small installation space and imposing a return force on the valve closing element such that said element closes quickly.

The return means is preferably clamped between the positioning means and the rear side of the valve seat.

The return means, preferably in the form of a return spring, is, in particular, held in a fixed location on the positioning means by means of a fixed bearing or a fixed clamping arrangement. By means of an outer area of the return means, said return means rests against the rear side of the valve seat under a preload. The return means thus exerts a pulling force on the valve closing element via the positioning means; the valve closing element is urged against the front side of the valve seat.

When a suction or pressure greater than the return force of the return means is applied to the valve closing element, the return means is deformed as the valve closing element is raised from the valve seat according to the distance traveled by the valve closing element.

The valve closing element is preferably of plate-shaped or cap-shaped configuration.

A valve of this kind provides a plate-shaped valve closing element which has a relatively small height or dimension in comparison with a spherical valve closing element. By virtue of the reduced height of such a valve closing element, it is possible to provide an inlet and/or outlet valve which has a very small dead volume, thereby increasing the efficiency of the hydraulic piston pump.

As an option, the valve closing element can also be configured as a cap, in particular a spherical cap, i.e. as a defined spherical segment or a defined spherical section, as a hemisphere or even as a cone.

The valve closing element and the positioning means are preferably formed integrally as an injection molding.

A development of this kind provides a “valve closing element/positioning means unit”, which is formed as an injection molding molded from plastic. By virtue of its shape, an injection molded plastic unit of this kind is particularly easy to mount on a valve seat and in a hydraulic piston pump in a forward direction, that is to say it can be joined easily to other components in the production process. Moreover a valve of this kind is robust and can be produced at low cost.

The invention furthermore provides a method for producing a valve according to the invention, comprising the following steps:
preparation of a valve seat having a front side and a rear side, with a valve opening being formed in the valve seat,
preparation of a valve closing element/positioning means unit comprising a valve closing element and a positioning means, and
introduction of the positioning means of the valve closing element/positioning means unit into the valve opening from the front side of the valve seat until the positioning means is arranged on the rear side of the valve seat and the valve closing element is arranged on the front side of the valve seat.

First of all, a valve seat is prepared. The valve seat is penetrated by a valve opening and has a front side and a rear side. A valve closing element/positioning means unit is furthermore prepared. This unit comprises a valve closing element for selective opening and closing of the valve opening, and a positioning means, preferably having an offset of elongate design in accordance with the features explained above. The valve closing element and the positioning means are preferably formed integrally.

The valve seat and the valve closing element/positioning means unit can be joined together to form a valve by means of a “forward-mounting process”. During this “forward-mounting process”, the valve closing element/positioning means unit is pushed or introduced into the valve opening with the positioning means at the front, more specifically from the front side of the valve seat, until the positioning means is accommodated by the valve opening and projects on the rear side of the valve seat.

If the positioning means comprises a latching element, the latching element is compressed or pressed together as it is introduced into the valve opening. Once the valve closing element/positioning means unit has been pushed far enough into the valve opening, the latching element spreads apart by virtue of its elasticity and latches in on the rear side of the valve seat, i.e. the valve closing element/positioning means unit hooks in on the rear side of the valve seat. The valve closing element is held captive on the valve seat.

The object according to the invention is furthermore achieved by means of a hydraulic piston pump having a valve according to the invention.

The hydraulic piston pump according to the invention comprises a cylinder and a piston, which is mounted in the cylinder in a manner which allows it to be extended and retracted. A pressure zone filled with a fluid is formed within the cylinder. As the piston is extended from the cylinder, a vacuum is built up in the pressure zone, and the piston sucks fluid into the pressure zone via an inlet valve. During retraction, on the other hand, the piston displaces the fluid from the pressure zone into a hydraulic system via an outlet valve in order to perform work.

The inlet and/or outlet valve is/are advantageously configured as a valve according to the invention in accordance with the abovementioned features and advantages. On the one hand, a valve of this kind ensures a high degree of robustness and good sealing behavior. On the other hand, a valve of this kind can be produced at low cost and is easy to integrate into the hydraulic piston pump.

In particular, the positioning means according to the invention requires only a small installation space; moreover, a relatively large helical return spring in accordance with the prior art, which is arranged on the front side of the valve seat, can be eliminated. As a result, it is possible, for example, to make available more installation space for a pulsation damping element provided in the piston pump, leading to improved damping behavior in the hydraulic piston pump.

Finally, a vehicle braking system having a hydraulic piston pump according to the invention is made available.

The vehicle braking system according to the invention comprises a hydraulic piston pump having a valve according to the invention in accordance with the features and advantages explained above.

A vehicle braking system of this kind can be an antilock braking system (ABS), a traction control system (TCS), an electronic stabilization program (ESP) or an electrohydraulic braking system (EHB), for example. It is particularly advantageous in such systems if the hydraulic piston pumps have valves that are robust and, at the same time, can be produced at low cost, ensure a high degree of leaktightness and provide optimum functioning of the braking system during long periods of operation. In particular, a low pressure pulsation level proves to be advantageous.

### BRIEF DESCRIPTION OF THE DRAWINGS

Illustrative embodiments of the solution according to the invention are explained in greater detail below with reference to the attached drawings, in which:

FIG. 1 shows a longitudinal section through a first illustrative embodiment of a valve according to the invention,

FIG. 2 shows a longitudinal section through a second illustrative embodiment of a valve according to the invention having a return spring,

FIG. 3 shows a view III in accordance with FIG. 2 of the return spring, and

FIG. 4 shows a longitudinal section through a third illustrative embodiment of a valve according to the invention.

### DESCRIPTION OF EMBODIMENTS

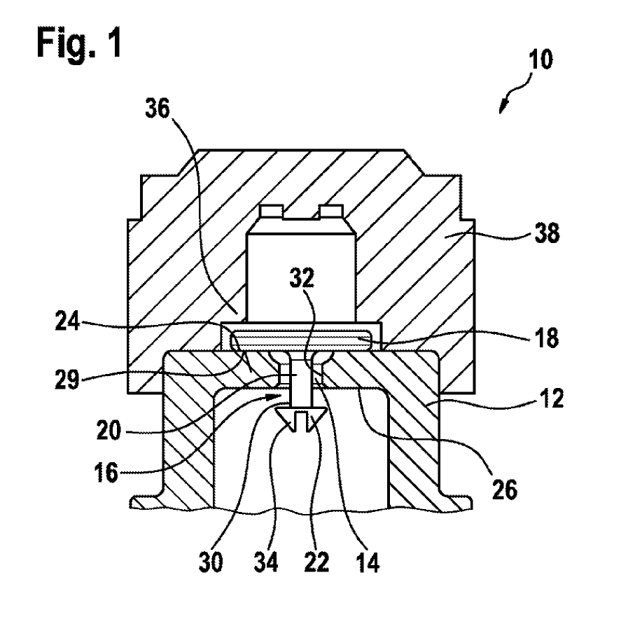

FIGS. 1, 3 and 4 each show a valve 10 for a hydraulic piston pump (not shown in further detail) of a vehicle braking system. The valve 10 comprises a valve seat 12, in which a circular valve opening 14 is formed. The valve 10 furthermore comprises a valve closing element/positioning means unit 16, which is formed integrally as a plastic injection molding by a plate-shaped valve closing element 18 and a positioning means 20. In the present case, a latching element 22 is formed integrally on the positioning means 20.

The valve seat 12 has a front side 24 and a rear side 26, the front side 24 being defined as the side on which the fluid, in the present case a brake fluid, flows into the valve opening 14, and the rear side 26 being defined as the side on which the fluid flows out of the valve opening 14.

According to FIG. 1, the valve 10 according to the invention is configured as an outlet valve of the hydraulic piston pump, but it can also be present as an inlet valve. The hydraulic piston pump furthermore comprises a piston, which can be extended and retracted in a cylinder and is driven by means of an eccentric. When the piston is extended from the cylinder, a vacuum is generated in a pressure zone within the cylinder. If this vacuum is greater than the inertia of the valve closing element 18, the valve closing element 18 is raised from the valve seat 12, and fluid flows into the pressure zone from a fluid inlet through the valve opening 14. As the piston is retracted into the cylinder, the fluid in the pressure zone is subjected to pressure and urged against the valve closing element 18 of the outlet valve 10. If the pressure exerted on the valve closing element 18 is greater than the inertia of the valve closing element 18, the valve closing element 16 is raised from the valve seat 12, and the fluid is passed into a hydraulic system in order to perform work.

The valve closing element 18 is arranged on the front side 24 of the valve seat 12 to allow selective opening and closing of the valve opening 14. The area in which the valve closing element 18 rests on the valve seat 12 in the closed state of the valve 10 forms a sealing surface 29, which ensures a substantially fluidtight seal.

The positioning means 20 is formed as a cylindrical offset 20, which starts on that side of the valve closing element 18 which faces the valve opening 14 and is accommodated within the valve opening 14. One end 28 of the positioning means 20 projects through the valve opening 14 on the rear side 26 of the valve seat 12. The latching element 22 is formed integrally on this end 28. Thus, the positioning means 20 is arranged on the rear side 26 of the valve seat 12 and connected to the valve closing element 18 through the valve opening 14.

The positioning means 20 is accommodated in the valve opening 14 in such a way that its outer wall 30 is spaced apart from an inner wall 32 of the valve opening 14. When the valve closing element 18 is raised from the valve seat 12, the fluid flows through the valve 10 between the outer wall 30 of the positioning means 20 and the inner wall 32 of the valve opening 14.

During the opening and closing of the valve 10, the positioning means 20 holds the valve closing element 18 relative to the valve seat 12, more specifically in the axial and radial directions relative to the valve seat and to the valve opening 14. The valve closing element 18 is guided over a defined distance. The positioning means 20 positions the valve closing element 18, in particular on the sealing surface 29, when the valve 10 is closed. The valve closing element 18 can thus be designed to be mounted in such a way as to be free, i.e. without a spring. According to FIG. 1, stroke limitation as the valve closing element 18 is raised from the valve seat 12, is accomplished by means of an offset 36, which is formed within a valve cover 38 of the outlet valve 10 and against which the valve closing element 18 strikes with a section of its end face.

The valve closing element/positioning means unit 16 forms a module with the latching element 22, and this module can be joined to the valve seat 12 in a simple manner. The unit 16 is pushed into the valve opening 14 from the front side 24 of the valve seat 12, with the end of the latching element 22 at the front. During this process, two legs 34 of the latching element 22, which are designed to be elastic relative to one another, are pressed together. Once the latching element 22 is arranged on the rear side 36 of the valve seat 12, the legs 34 spread apart again and latch in on the rear side 26 of the valve seat 12. The valve closing element/positioning means unit 16 is then mounted in a captive manner on the valve seat 12.

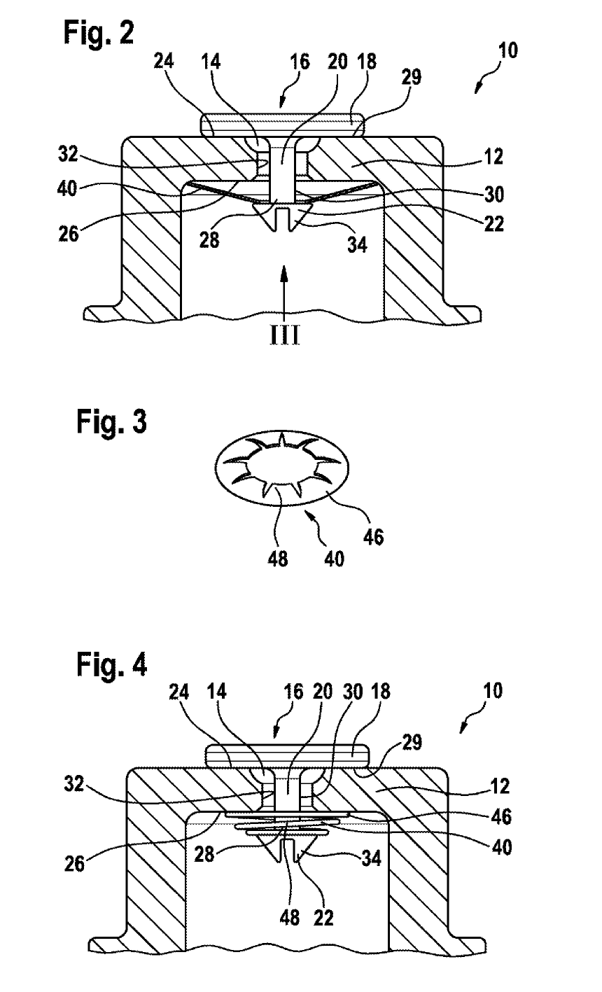

FIGS. 2 and 4 each show a valve 10 in accordance with FIG. 1, to which a return means in the form of a return spring 40 is assigned. According to FIGS. 2 and 3, the return spring 40 is designed as a spring plate and, according to FIG. 4, is designed as a spiral spring. This type of return spring 40 is particularly easy to integrate into a valve 10 according to the invention.

According to FIGS. 2 to 4, the return spring 40 is arranged on the rear side 26 of the valve seat 12 and imposes a return force on the valve closing element 18, namely a pulling force, thus urging the valve closing element 18 against the front side 24 of the valve seat 12. In this arrangement, the return spring 40 is clamped between the positioning means 20 and the rear side 26 of the valve seat 12.

When the pressure or suction exerted by the fluid is greater than the return force of the return spring 40, and the valve closing element 18 is raised from the valve seat 12, the return spring 40 is deformed. During this process, an outer area 46 of the return spring 40 presses against the rear side 26 of the valve seat 12, and a central area 48, which is connected in a fixed location to the positioning means 20, is moved by a stroke defined by the clamping force on the return spring 40. As the valve closing element 18 is raised from the valve seat 12, therefore, the return spring 40 is deformed in accordance with the distance traveled by the valve closing element 18. The return means of this kind is integrated in a space-saving manner in the valve 10. In the present case, the stroke limitation can also be achieved by means of the latching element 22, namely when the latter strikes against the rear side 26 of the valve seat 12.

A low-cost and robust valve 10 has therefore been provided, and this valve ensures a good sealing effect while closing easily and quickly and can be integrated easily into a hydraulic piston pump. Since there is no need to arrange a helical return spring on the front side 24 of the valve seat 12, the valve 10 has small dimensions. Installation space is minimized. As a result, a larger installation space can be made available in the hydraulic piston pump for a pulsation damping element, and, as a result, it is possible to reduce the level of pulsation in the piston pump.

In the present case, the valve 10 according to the invention is illustrated as a plate valve 10, since a valve 10 of this kind ensures a small dead volume in the piston pump. However, other valve geometries are also conceivable, e.g. cap-shaped, hemispherical or ball valves.

1. A valve of a hydraulic piston pump comprising:
a valve seat including:
a valve opening formed in the valve seat;
a front side; and
a rear side;
a valve closing element arranged on the front side of the valve seat and configured to selectively open and close the valve opening; and
a positioning mechanism configured to hold the valve closing element relative to the valve seat, wherein the positioning mechanism is arranged on the rear side of the valve seat and is connected to the valve closing element through the valve opening.

2. The valve as claimed in claim 1, wherein the positioning mechanism is configured to position the valve closing element in a direction of a longitudinal extent of the valve.

3. The valve as claimed in claim 1, wherein the positioning mechanism is configured to position the valve closing element transversely to a longitudinal extent of the valve.

4. The valve as claimed in claim 1, wherein the positioning mechanism includes a latching element latched in on the rear side of the valve seat.

5. The valve as claimed in claim 1, further comprising:
a return mechanism arranged on the rear side of the valve seat and configured to urge the valve closing element against the valve seat.

6. The valve as claimed in claim 5, wherein the return mechanism is clamped between the positioning mechanism and the rear side of the valve seat.

7. The valve as claimed in claim 1, wherein the valve closing element has one of a plate-shaped configuration and a cap-shaped configuration.

8. The valve as claimed in claim 1, wherein the valve closing element and the positioning mechanism are formed integrally by injection molding.

9. A method for producing a valve, comprising:
preparing a valve seat having a front side and a rear side, and having a valve opening formed in the valve seat,
preparing a valve closing element and positioning mechanism unit including a valve closing element and a positioning mechanism, and
introducing the positioning mechanism of the valve closing element and positioning mechanism unit into the valve opening from the front side of the valve seat until the positioning mechanism is arranged on the rear side of the valve seat and the valve closing element is arranged on the front side of the valve seat.

10. A hydraulic piston pump comprising:
a valve including:
a valve seat having:
a valve opening formed in the valve seat;
a front side; and
a rear side;
a valve closing element arranged on the front side of the valve seat and configured to selectively open and close the valve opening; and
a positioning mechanism configured to hold the valve closing element relative to the valve seat, wherein the positioning mechanism is arranged on the rear side of the valve seat and is connected to the valve closing element through the valve opening.

11. The hydraulic piston pump as claimed in claim 10, wherein the hydraulic piston pump is a component of a vehicle braking system.
